(19) United States
(12) Patent Application Publication
(10) Pub. No.: US 2019/0181506 A1
(43) Pub. Date: Jun. 13, 2019

(54) PASTING PAPER FOR BATTERIES COMPRISING MULTIPLE FIBER TYPES

(71) Applicant: Hollingsworth & Vose Company, East Walpole, MA (US)

(72) Inventors: Nicolas Clement, Littleton, MA (US); Zhiping Jiang, Nashua, NH (US)

(73) Assignee: Hollingsworth & Vose Company, East Walpole, MA (US)

(21) Appl. No.: 15/839,810

(22) Filed: Dec. 12, 2017

(51) Int. Cl. H01M 10/12; H01M 4/21; C08J 5/08; C08L 1/02; D21H 11/10; H01M 2/16; H01M 4/36

(52) U.S. Cl. CPC H01M 10/121; H01M 4/21; C08J 5/08; H01M 4/366; D21H 11/10; H01M 2/1606; H01M 2/1686; C08L 1/02

(57) ABSTRACT

Articles and methods involving pasting papers are generally provided. In certain embodiments, a pasting paper may comprise a plurality of cellulose fibers, a plurality of multicomponent fibers, and a plurality of glass fibers. In some embodiments, the average fiber diameter of each plurality of fibers is greater than or equal to 1 micron. In some embodiments, a pasting paper may have a thickness of less than 0.2 mm, an air permeability of less than or equal to 300 CFM, a 1.28 spg sulfuric acid wicking height of greater than 3 cm, and/or may be configured to have a dry tensile strength in a machine direction of greater than or equal to 1 lb/in after storage in 1.28 spg sulfuric acid at 75° C. for 168 hours. In some embodiments, a pasting paper may be disposed on a battery paste, such as a battery paste for use in a lead-acid battery. In certain cases, forming a battery plate may comprise disposing a pasting paper on a battery paste. In certain cases, a lead-acid battery may be assembled by assembling a first battery plate comprising a pasting paper with a separator and a second battery plate.

### FIELD

The present invention relates generally to pasting papers and, more particularly, to pasting papers comprising multiple types of fibers.

### BACKGROUND

Pasting papers may be used to aid assembly of batteries (e.g., lead-acid batteries) by increasing the ease of manipulation of battery plates. Many pasting papers have properties that are advantageous for either battery use or battery assembly, but not for both.

Accordingly, improved compositions and methods are needed.

### SUMMARY

Pasting papers as well as related components and methods associated therewith are provided.

In some embodiments, lead-acid batteries are provided. The lead-acid battery comprises a battery plate comprising lead and a pasting paper disposed on the battery plate. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % of the non-woven fiber web based on the total weight of the non-woven fiber web.

In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % and less than or equal to 80 wt % of the non-woven fiber web based on the total weight of the non-woven fiber web. The plurality of multicomponent fibers makes up greater than or equal to 10 wt % and less than or equal to 50 wt % of the non-woven fiber web based on the total weight of the non-woven fiber web. The plurality of glass fibers makes up greater than or equal to 10 wt % and less than or equal to 50 wt % of the non-woven fiber web based on the total weight of the non-woven fiber web. In some cases, the pasting paper has a thickness of less than 0.2 mm.

In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The pasting paper has a thickness of less than 0.2 mm, an air permeability of less than or equal to 300 CFM, a 1.28 spg sulfuric acid wicking height of greater than or equal to 3 cm, and/or is configured to have a dry tensile strength in a machine direction of greater than or equal to 1 lb/in after storage in 1.28 spg sulfuric acid at 75° C. for 7 days.

In some embodiments, methods of forming battery plates are provided. A method of forming a battery plate comprises disposing a pasting paper on a battery paste comprising lead. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

In some embodiments, methods of assembling lead-acid batteries are provided. A method of assembling a lead-acid battery comprises assembling a first battery plate comprising lead with a separator and a second battery plate to form a lead-acid battery. A pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

In some embodiments, methods of forming lead-acid batteries are provided. A method of forming a lead-acid battery comprises assembling a first battery plate comprising lead with a separator, an electrolyte, and a second battery plate to form a lead-acid battery. The pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web. The method further comprises dissolving at least a portion of the plurality of cellulose fibers within the pasting paper in the electrolyte.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a schematic depiction of a pasting paper, according to certain embodiments;

FIG. 2 shows a schematic depiction of a pasting paper disposed on a battery plate, according to certain embodiments; and

FIG. 3 shows a schematic depiction of a battery, according to certain embodiments.

### DETAILED DESCRIPTION

Articles and methods involving pasting papers are generally provided. In some embodiments, a pasting paper comprises a non-woven fiber web comprising a combination of fiber types that is particularly advantageous. For instance, a pasting paper may comprise a non-woven fiber web comprising multiple types of fibers, each of which provides certain advantages to the pasting paper, and/or compensates for one or more disadvantages of other types of fibers also present in the pasting paper.

As an example of one fiber type, in some embodiments, a pasting paper may comprise a non-woven fiber web comprising a plurality of glass fibers. The glass fibers may strengthen the pasting paper and increase its hydrophilicity, but may not adhere together well in the absence of a component binding them together.

As another example of a fiber type, in some embodiments, a pasting paper may comprise a non-woven fiber web comprising a plurality of multicomponent fibers. The multicomponent fibers may be weaker than glass fibers and/or less hydrophilic than glass fibers, but may bond glass fibers together. In some cases, it may be beneficial to bond glass fibers using multicomponent fibers. The use of multicomponent fibers for this purpose may result in a fiber web that is less hydrophobic compared to the use of other materials that may be employed to bond glass fibers together, such as binder resins.

As a third example of a fiber type, in some embodiments, a pasting paper may comprise a non-woven fiber web comprising a plurality of fibers that enables the pasting paper to have different properties prior to battery assembly than during battery cycling. For example, a pasting paper may comprise a non-woven fiber web comprising a plurality of cellulose fibers, which may be soluble in an electrolyte present in the battery. The plurality of cellulose fibers may reduce the mean pore size and air permeability of the pasting paper prior to exposure to the electrolyte and increase the hydrophilicity of the pasting paper, resulting in a pasting paper with a lower mean pore size, lower air permeability, and/or higher hydrophilicity than an otherwise equivalent pasting paper lacking these fibers. In turn, these fibers may increase the wicking height of the pasting paper and/or enhance initial transport of the electrolyte into the pasting paper. Upon exposure to the electrolyte, the plurality of cellulose fibers may partially or fully dissolve, leaving behind a non-woven fiber web made up of relatively larger amounts of other fiber types. Pasting papers comprising a plurality of fibers with this property, such as a plurality of cellulose fibers, may have a less open structure prior to battery assembly, reducing wet battery paste bleeding and/or dry battery paste dusting during fabrication, and may have a more open structure during battery usage, facilitating electrolyte and/or gas transport across the pasting paper. The amount of cellulose fibers employed may be selected such that the pasting paper still retains structural integrity after cellulose dissolution, and/or has an appropriate pore size and/or tensile strength such that battery paste shedding is minimized.

In some embodiments, a pasting paper includes some or all of the fibers types described above. Other fiber types are also possible as described in more detail below.

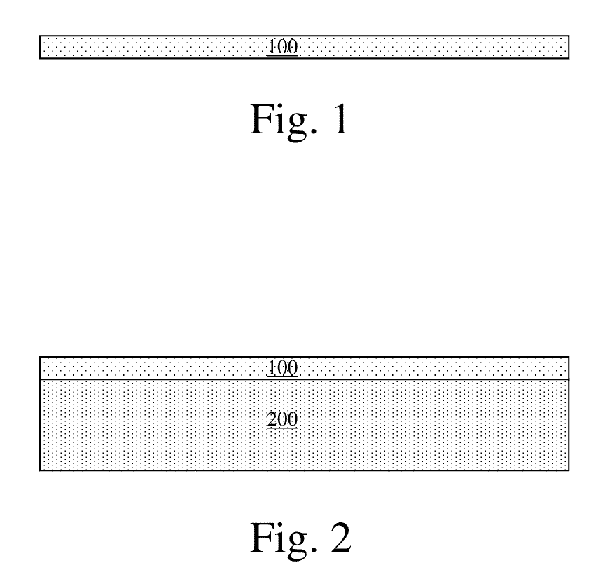

As described above, pasting papers are generally provided. FIG. 1 shows one non-limiting example of a pasting paper 100. Some articles and methods relate to pasting papers, such as that shown in FIG. 1; some articles and methods relate to the use of pasting papers, such as that shown in FIG. 1, in batteries, such as lead-acid batteries. For instance, pasting papers as described herein may be employed during the formation of battery plates (e.g., lead battery plates for lead-acid batteries, lead dioxide plates for lead-acid batteries). Certain articles described herein may comprise pasting papers disposed on battery plates; certain methods may comprise forming such articles by disposing pasting papers on battery pastes.

In certain embodiments, a pasting paper disposed on a battery plate may aid handling of the battery plate. The pasting paper-covered battery plate may be easier to manipulate than an uncovered battery plate. FIG. 2 shows one non-limiting example of a pasting paper 100 disposed on a battery plate 200. In some embodiments, the battery plate may further comprise one or more additional components, such as a grid on which the battery paste is disposed (not shown). It should be noted that, although FIG. 2 shows the pasting paper and the battery plate as fully separate layers, in some embodiments the pasting paper may be partially and/or fully embedded in the battery plate. For instance, the pasting paper may be positioned such that at least a portion of the battery plate (e.g., the battery paste therein) penetrates into at least a portion of the pasting paper, and/or such that at least a portion of the pasting paper penetrates into at least a portion of the battery plate (e.g., into at least a portion of the battery paste therein). The surface of the pasting paper opposite the battery plate is typically free from any components present the battery plate (e.g., it is typically free from the battery paste in the battery plate). In other words, the surface of the pasting paper opposite the battery plate is typically not embedded in the battery plate.

As used herein, when a battery component is referred to as being “disposed on” another battery component, it can be directly disposed on the battery component, or an intervening battery component also may be present. A battery component that is “directly disposed on” another battery component means that no intervening battery component is present.

When disposed on a battery plate, a pasting paper may cover the battery plate during subsequent battery fabrication steps such as cutting the battery plate to size, drying and/or curing the battery plate in an oven, and assembling the battery plate with other battery components. The presence of the pasting paper on the battery plate during such steps may be advantageous. For instance, in some cases, the pasting paper may have a relatively low permeability to a battery paste. As an example, in the case of a pasting paper configured to be disposed on battery plates comprising lead particles, the pasting paper may have a relatively low permeability to lead particles. Relatively low amounts of wet lead and/or dry lead may be capable of passing through the pasting paper (e.g., the pasting paper may exhibit relatively low levels of wet lead bleeding and/or dry lead dusting therethrough). As another example, in the case of a pasting paper configured to be disposed on battery plates comprising lead dioxide particles, the pasting paper may have a relatively low permeability to lead dioxide particles. Relatively low amounts of wet lead dioxide and/or dry lead dioxide may be capable of passing through the pasting paper (e.g., the pasting paper may exhibit relatively low levels of wet lead dioxide bleeding and/or dry lead dioxide dusting therethrough). In such cases, the presence of a pasting paper disposed on the battery plate may also reduce exposure of individuals handling the battery plate to components of the battery plate (e.g., hazardous components, such as lead particles and/or lead dioxide particles in pasting papers configured for use in lead-acid batteries), and/or may reduce sticking between adjacent battery plates.

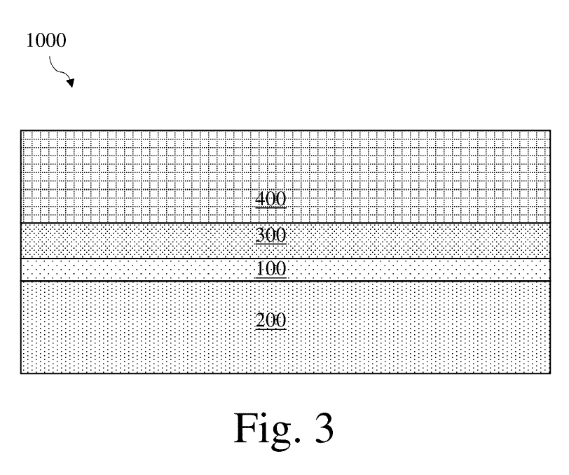

In some embodiments, a battery plate on which a pasting paper is disposed may be incorporated into a battery. For example, certain methods described herein may comprise positioning a battery plate (e.g., a battery plate on which a pasting paper is disposed) in a battery. The pasting paper may be positioned on a battery plate during battery plate processing, and then not removed from the battery plate prior to incorporation of the battery plate into a battery. As another example, certain methods may comprise assembling a battery, such as a lead-acid battery. The battery may be assembled by assembling a first battery plate on which a pasting paper is disposed with other battery components. These components may include one or more of a second battery plate, a separator, an electrolyte, and one or more current collectors. FIG. 3 shows one non-limiting example of a battery 1000 comprising a pasting paper 100, a first battery plate 200, a separator 300, and a second battery plate 400. It should be understood that pasting papers described herein may be incorporated into batteries comprising fewer components than those shown in FIG. 3 (e.g., batteries lacking a separator), and/or may be incorporated into batteries comprising more components than those shown in FIG. 3 (e.g., batteries comprising one or more current collectors). Other configurations are also possible.

In some embodiments, a battery plate and a pasting paper disposed thereon may be exposed to an electrolyte (e.g., during battery fabrication, during battery assembly). In certain cases, at least a portion of the pasting paper may dissolve in the electrolyte upon exposure of the battery plate and the pasting paper to the electrolyte. The remaining pasting paper may have a more open structure (e.g., as evidenced by a larger mean pore size and/or larger air permeability), and so may be more permeable to the electrolyte and/or gas, than the pasting paper prior to partial dissolution. The more open structure may still be sufficiently strong and impermeable to the battery paste (e.g., lead, lead dioxide) to prevent appreciable battery paste shedding (e.g., lead shedding, lead dioxide shedding). For instance, the pasting paper may initially comprise a non-woven fiber web comprising a plurality of cellulose fibers that are configured to dissolve in the electrolyte (e.g., an electrolyte such as sulfuric acid, such as sulfuric acid at a concentration of 1.28 spg), and pluralities of glass fibers and multicomponent fibers that are configured to not dissolve in the electrolyte. After dissolution of at least a portion of the pasting paper (e.g., at least a portion of the plurality of cellulose fibers, or the entirety of the plurality of cellulose fibers), the non-woven fiber web may still comprise the plurality of glass fibers and the plurality of multicomponent fibers. These remaining fibers may make up a sufficient percentage of the non-woven fiber web and may be bound together sufficiently strongly to provide advantages to the resulting battery, such as preventing battery paste shedding.

As described above, in certain embodiments, a pasting paper may comprise a non-woven fiber web comprising a plurality of glass fibers. When present, all of the glass fibers within a plurality of glass fibers may together make up any suitable amount of the non-woven fiber web or the pasting paper. In other words, the total amount of glass fibers (e.g., the total amount of fibers that are microglass fibers, chopped strand glass fibers, or any other type of glass fiber) in the non-woven fiber web or the pasting paper may be selected as desired. Glass fibers may make up greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, or greater than or equal to 60 wt % of the non-woven fiber web or the pasting paper. Glass fibers may make up less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less than or equal to 5 wt % of the non-woven fiber web or the pasting paper. Combinations of the above-referenced ranges are also possible (e.g., greater than or equal to 2 wt % and less than or equal to 70 wt % of the non-woven fiber web or the pasting paper, greater than or equal to 10 wt % and less than or equal to 50 wt % of the non-woven fiber web or the pasting paper, or greater than or equal to 20 wt % and less than or equal to 30 wt % of the non-woven fiber web or the pasting paper). Other ranges are also possible. In some embodiments, the ranges above for weight percentage are based on the total weight of the non-woven fiber web or the pasting paper. For example, the glass fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the glass fibers may be present in an amount of greater than or equal to 2 wt % and less than or equal to 70 wt % of the total amount of fibers in the non-woven fiber web or the pasting paper.

When glass fibers are present in a pasting paper, the average fiber diameter of all of the glass fibers may be any suitable value. In other words, the average diameter of the glass fibers (e.g., the average diameter of fibers that are microglass fibers, chopped strand glass fibers, or any other type of glass fiber) in the non-woven fiber web or the pasting paper may be selected as desired. The average fiber diameter of the glass fibers may be greater than or equal to 1 micron, greater than or equal to 2 microns, greater than or equal to 5 microns, greater than or equal to 10 microns, greater than or equal to 15 microns, greater than or equal to 20 microns, or greater than or equal to 25 microns. The average fiber diameter of the glass fibers may be less than or equal to 30 microns, less than or equal to 25 microns, less than or equal to 20 microns, less than or equal to 15 microns, less than or equal to 10 microns, less than or equal to 5 microns, or less than or equal to 2 microns. Combinations of the above-referenced ranges are also possible (e.g., greater than or equal to 1 micron and less than or equal to 30 microns, greater than or equal to 1 micron and less than or equal to 20 microns, or greater than or equal to 1 micron and less than or equal to 15 microns). Other ranges are also possible. One of ordinary skill in the art would be familiar with techniques that may be used to determine the average fiber diameter of glass fibers in a non-woven fiber web or pasting paper. An example of one suitable technique is scanning electron microscopy.

When glass fibers are present in a pasting paper, the average length of all of the glass fibers may be any suitable value. In other words, the average length of the glass fibers (e.g., the average length of fibers that are microglass fibers, chopped strand glass fibers, or any other type of glass fiber) in the non-woven fiber web or the pasting paper may be selected as desired. The average length of the glass fibers may be greater than or equal to 0.1 mm, greater than or equal to 0.2 mm, greater than or equal to 0.5 mm, greater than or equal to 1 mm, greater than or equal to 2 mm, greater than or equal to 5 mm, greater than or equal to 10 mm, greater than or equal to 15 mm, or greater than or equal to 20 mm. The average length of the glass fibers may be less than or equal to 25 mm, less than or equal to 20 mm, less than or equal to 15 mm, less than or equal to 10 mm, less than or equal to 5 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 25 mm, greater than or equal to 0.1 mm and less than or equal to 25 mm, or greater than or equal to 0.2 mm and less than or equal to 15 mm). Other ranges are also possible.

In some embodiments, the glass fibers present in a pasting paper may be microglass fibers and/or chopped strand glass fibers.

In some embodiments, a plurality of glass fibers may comprise microglass fibers. When present, the microglass fibers may make up greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, or greater than or equal to 60 wt % of the non-woven fiber web or the pasting paper. When present, the microglass fibers may make up less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less than or equal to 5 wt % of the non-woven fiber web or the pasting paper. Combinations of the above-referenced ranges are also possible (e.g., greater than or equal to 2 wt % and less than or equal to 70 wt % of the non-woven fiber web or the pasting paper, greater than or equal to 10 wt % and less than or equal to 50 wt % of the non-woven fiber web or the pasting paper, or greater than or equal to 20 wt % and less than or equal to 30 wt % of the non-woven fiber web or the pasting paper). Other ranges are also possible. In some embodiments, the ranges above for weight percentage are based on the total weight of the non-woven fiber web or the pasting paper. For example, the microglass fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the microglass fibers may be present in an amount of greater than or equal to 2 wt % and less than or equal to 70 wt % of the total amount of fibers in the non-woven fiber web or the pasting paper.

When present, a plurality of microglass fibers may comprise any suitable type(s) of microglass fibers. The plurality of microglass fibers may comprise microglass fibers drawn from bushing tips and further subjected to flame blowing or rotary spinning processes. In some cases, microglass fibers may be made using a remelting process. The plurality of microglass fibers may comprise microglass fibers for which alkali metal oxides (e.g., sodium oxides, magnesium oxides) make up 10-20 wt % of the fibers. Such fibers may have relatively lower melting and processing temperatures. Non-limiting examples of microglass fibers are M-glass fibers according to Man Made Vitreous Fibers by Nomenclature Committee of TIMA Inc. March 1993, Page 45.

When present, the microglass fibers may have any suitable average fiber diameter. The average fiber diameter of the microglass fibers may be greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, or greater than or equal to 9 microns. The average fiber diameter of the microglass fibers may be less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, or less than or equal to 2 microns. Combinations of the above-referenced ranges are also possible (e.g., greater than or equal to 1 micron and less than or equal to 10 microns, greater than or equal to 1 micron and less than or equal to 5 microns, or greater than or equal to 1 micron and less than or equal to 2 microns). Other ranges are also possible. One of ordinary skill in the art would be familiar with techniques that may be used to determine the average fiber diameter of microglass fibers in a non-woven fiber web or pasting paper. An example of one suitable technique is scanning electron microscopy.

When present, the microglass fibers may have any suitable average length. The average length of the microglass fibers may be greater than or equal to 0.1 mm, greater than or equal to 0.2 mm, greater than or equal to 0.5 mm, greater than or equal to 0.7 mm, greater than or equal to 1 mm, greater than or equal to 1.2 mm, greater than or equal to 1.5 mm, or greater than or equal to 1.7 mm. The average length of the microglass fibers may be less than or equal to 2 mm, less than or equal to 1.7 mm, less than or equal to 1.5 mm, less than or equal to 1.2 mm, less than or equal to 1 mm, less than or equal to 0.7 mm, less than or equal to 0.5 mm, or less than or equal to 0.2 mm. Combinations of the above-referenced ranges are also possible (e.g., greater than or equal to 0.1 mm and less than or equal to 2 mm, greater than or equal to 0.1 mm and less than or equal to 1 mm, or greater than or equal to 0.1 mm and less than or equal to 0.7 mm). Other ranges are also possible.

In some embodiments, a pasting paper may comprise a plurality of glass fibers, and the plurality of glass fibers may comprise chopped strand glass fibers. When the chopped strand glass fibers are present, they may make up greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, or greater than or equal to 60 wt % of the non-woven fiber web or the pasting paper. When present, the chopped strand glass fibers may make up less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less than or equal to 5 wt % of the non-woven fiber web or the pasting paper. Combinations of the above-referenced ranges are also possible (e.g., greater than or equal to 2 wt % and less than or equal to 70 wt % of the non-woven fiber web or the pasting paper, greater than or equal to 10 wt % and less than or equal to 50 wt % of the non-woven fiber web or the pasting paper, or greater than or equal to 20 wt % and less than or equal to 30 wt % of the non-woven fiber web or the pasting paper). Other ranges are also possible. In some embodiments, the ranges above for weight percentage are based on the total weight of the non-woven fiber web or the pasting paper. For example, the chopped strand glass fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the chopped strand glass fibers may be present in an amount of greater than or equal to 2 wt % and less than or equal to 70 wt % of the total amount of fibers in the non-woven fiber web or the pasting paper.

When present, a plurality of chopped strand glass fibers may comprise any suitable type(s) of chopped strand glass fibers. The plurality of chopped strand glass fibers may comprise chopped strand glass fibers which were produced by drawing a melt of glass from bushing tips into continuous fibers and then cutting the continuous fibers into short fibers. The plurality of chopped strand glass fibers may comprise chopped strand glass fibers for which alkali metal oxides (e.g., sodium oxides, magnesium oxides) make up a relatively low amount of the fibers. Certain chopped strand glass fibers may include relatively large amounts of calcium oxide and/or alumina.

When present, the chopped strand glass fibers may have any suitable average fiber diameter. The average fiber diameter of the chopped strand glass fibers may be greater than or equal to 5 microns, greater than or equal to 7 microns, greater than or equal to 10 microns, greater than or equal to 12 microns, greater than or equal to 15 microns, greater than or equal to 17 microns, greater than or equal to 20 microns, greater than or equal to 22 microns, greater than or equal to 25 microns, or greater than or equal to 27 microns. The average fiber diameter of the chopped strand glass fibers may be less than or equal to 30 microns, less than or equal to 27 microns, less than or equal to 25 microns, less than or equal to 22 microns, less than or equal to 20 microns, less than or equal to 17 microns, less than or equal to 15 microns, less than or equal to 12 microns, less than or equal to 10 microns, or less than or equal to 7 microns. Combinations of the above-referenced ranges are also possible (e.g., greater than or equal to 5 microns and less than or equal to 30 microns, greater than or equal to 10 microns and less than or equal to 30 microns, greater than or equal to 10 microns and less than or equal to 20 microns, or greater than or equal to 10 microns and less than or equal to 15 microns). Other ranges are also possible. One of ordinary skill in the art would be familiar with techniques that may be used to determine the average fiber diameter of chopped strand glass fibers in a non-woven fiber web or pasting paper. An example of one suitable technique is scanning electron microscopy.

When present, the chopped strand glass fibers may have any suitable average length. The average length of the chopped strand glass fibers may be greater than or equal to 2 mm, greater than or equal to 4 mm, greater than or equal to 5 mm, greater than or equal to 10 mm, greater than or equal to 15 mm, or greater than or equal to 20 mm. The average length of the chopped strand glass fibers may be less than or equal to 25 mm, less than or equal to 20 mm, less than or equal to 15 mm, less than or equal to 10 mm, less than or equal to 5 mm, or less than or equal to 4 mm. Combinations of the above-referenced ranges are also possible (e.g., greater than or equal to 2 mm and less than or equal to 25 mm, greater than or equal to 4 mm and less than or equal to 20 mm, or greater than or equal to 5 mm and less than or equal to 15 mm). Other ranges are also possible.

As described above, in certain embodiments, a pasting paper may comprise a non-woven fiber web comprising a plurality of multicomponent fibers. When present, the multicomponent fibers may make up any suitable amount of the fiber web or the pasting paper. The multicomponent fibers may make up greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 60 wt % of the non-woven fiber web or the pasting paper. The multicomponent fibers may make up less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, or less than or equal to 2 wt % of the non-woven fiber web or the pasting paper. Combinations of the above-referenced ranges are also possible (e.g., greater than or equal to 2 wt % and less than or equal to 70 wt % of the non-woven fiber web or the pasting paper, greater than or equal to 10 wt % and less than or equal to 50 wt % of the non-woven fiber web or the pasting paper, or greater than or equal to 25 wt % and less than or equal to 45 wt % of the non-woven fiber web or the pasting paper). Other ranges are also possible. In some embodiments, the ranges above for weight percentage are based on the total weight of the non-woven fiber web or the pasting paper. For example, the multicomponent fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the multicomponent fibers may be present in an amount of greater than or equal to 2 wt % and less than or equal to 70 wt % of the total amount of fibers in the non-woven fiber web or the pasting paper.

When present, the plurality of multicomponent fibers may comprise any suitable types of multicomponent fibers. The multicomponent fibers may include more than one component in each fiber. Non-limiting examples of suitable components that may be present in multicomponent fibers include polyolefins such as poly(ethylene) (PE), poly(propylene) (PP), and poly(butylene); polyesters and/or co-polyesters such as poly(ethylene terephthalate) (PET) and poly(butylene terephthalate) (PBT); polyamides such as nylons and aramids; and halogenated polymers such as polytetrafluoroethylene.

In some embodiments, a plurality of multicomponent fibers may comprise bicomponent fibers. It should be understood that bicomponent fibers may make any of the amounts of the non-woven fiber web or the pasting paper described above with respect to multicomponent fibers (e.g., the bicomponent fibers may make up greater than or equal to 2 wt % and less than or equal to 70 wt % of the non-woven fiber web or the pasting paper based on the total weight of the non-woven fiber web or the pasting paper, the bicomponent fibers may make up greater than or equal to 2 wt % and less than or equal to 70 wt % of the non-woven fiber web or the pasting paper based on the total amount of fibers in the non-woven fiber web or the pasting paper). When present, the bicomponent fibers have any suitable structure, such as core/sheath (e.g., concentric core/sheath, non-concentric core-sheath), split fibers, side-by-side fibers, and “island in the sea” fibers. When core-sheath bicomponent fibers are present, the sheath may have a lower melting temperature than the core. When heated, the sheath may melt prior to the core, binding other fibers within a non-woven fiber web or pasting paper together while the core remains solid. Non-limiting examples of suitable bicomponent fibers, in which the component with the lower melting temperature is listed first and the component with the higher melting temperature is listed second, include the following: PE/PET, PP/PET, Co-PET/PET, PBT/PET, co-polyamide/polyamide, and PE/PP.

When present, the multicomponent fibers may have any suitable average fiber diameter. The average fiber diameter of the multicomponent fibers may be greater than or equal to 1 micron, greater than or equal to 2 microns, greater than or equal to 5 microns, greater than or equal to 10 microns, greater than or equal to 15 microns, greater than or equal to 20 microns, or greater than or equal to 25 microns. The average fiber diameter of the multicomponent fibers may be less than or equal to 30 microns, less than or equal to 25 microns, less than or equal to 20 microns, less than or equal to 15 microns, less than or equal to 10 microns, less than or equal to 5 microns, or less than or equal to 2 microns. Combinations of the above-referenced ranges are also possible (e.g., greater than or equal to 1 micron and less than or equal to 30 microns, greater than or equal to 5 microns and less than or equal to 20 microns, or greater than or equal to 10 microns and less than or equal to 15 microns). Other ranges are also possible. One of ordinary skill in the art would be familiar with techniques that may be used to determine the average fiber diameter of multicomponent fibers in a non-woven fiber web or pasting paper. An example of one suitable technique is scanning electron microscopy.

When present, the multicomponent fibers may have any suitable average length. The average length of the multicomponent fibers may be greater than or equal to 2 mm, greater than or equal to 4 mm, greater than or equal to 5 mm, greater than or equal to 10 mm, greater than or equal to 15 mm, or greater than or equal to 20 mm. The average length of the multicomponent fibers may be less than or equal to 25 mm, less than or equal to 20 mm, less than or equal to 15 mm, less than or equal to 10 mm, less than or equal to 5 mm, less than or equal to 4 mm, or less than or equal to 2 mm. Combinations of the above-referenced ranges are also possible (e.g., greater than or equal to 2 mm and less than or equal to 25 mm, greater than or equal to 4 mm and less than or equal to 20 mm, or greater than or equal to 5 mm and less than or equal to 15 mm). Other ranges are also possible.

As described above, in certain embodiments, a pasting paper may comprise a non-woven fiber web comprising a plurality of cellulose fibers. The cellulose fibers may be soluble in certain electrolytes (e.g., sulfuric acid, such as 1.28 spg sulfuric acid), and may at least partially dissolve in an electrolyte to which the pasting paper is exposed during and/or after battery fabrication. When present, the cellulose fibers may make up any suitable amount of the non-woven fiber web or the pasting paper. The cellulose fibers may make up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of the non-woven fiber web or the pasting paper. The cellulose fibers may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, or less than or equal to 15 wt % of the non-woven fiber web or the pasting paper. Combinations of the above-referenced ranges are also possible (e.g., greater than or equal to 10 wt % and less than or equal to 95 wt % of the non-woven fiber web or the pasting paper, greater than or equal to 20 wt % and less than or equal to 80 wt % of the non-woven fiber web or the pasting paper, or greater than or equal to 25 wt % and less than or equal to 55 wt % of the non-woven fiber web or the pasting paper). Other ranges are also possible. In some embodiments, the ranges above for weight percentage are based on the total weight of the non-woven fiber web or the pasting paper. For example, the cellulose fibers may be present in an amount of greater than or equal to 10 wt % and less than or equal to 95 wt % of the total weight of the non-woven fiber web or the pasting paper. In some embodiments, the ranges above for weight percentage are based on the total amount of fibers in the non-woven fiber web or the pasting paper. For example, the cellulose fibers may be present in an amount of greater than or equal to 10 wt % and less than or equal to 95 wt % of the total amount of fibers in the non-woven fiber web or the pasting paper.

When present, the cellulose fibers may comprise any suitable types of cellulose. In some embodiments, the cellulose fibers may comprise natural cellulose fibers, such as cellulose wood (e.g., cedar), softwood fibers, and/or hardwood fibers. Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”).

In some embodiments, a pasting paper may comprise a non-woven fiber web comprising cellulose fibers other than natural cellulose fibers. As an example, the cellulose fibers may comprise regenerated and/or synthetic cellulose such as lyocell, rayon, and celluloid. As another example, the cellulose fibers comprise natural cellulose derivatives, such as cellulose acetate and carboxymethylcellulose.

The cellulose fibers, when present, may comprise fibrillated cellulose fibers, and/or may comprise unfibrillated cellulose fibers.

When present, the cellulose fibers may have any suitable average fiber diameter. The average fiber diameter of the cellulose fibers may be greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, or greater than or equal to 70 microns. The average fiber diameter of the cellulose fibers may be less than or equal to 75 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 5 microns, less than or equal to 2 microns, less than or equal to 1 micron, less than or equal to 0.5 microns, or less than or equal to 0.2 microns. Combinations of the above-referenced ranges are also possible (e.g., greater than or equal to 0.1 micron and less than or equal to 75 microns, greater than or equal to 1 micron and less than or equal to 40 microns, or greater than or equal to 10 microns and less than or equal to 30 microns). Other ranges are also possible. One of ordinary skill in the art would be familiar with techniques that may be used to determine the average fiber diameter of cellulose fibers in a non-woven fiber web or pasting paper. An example of one suitable technique is scanning electron microscopy.

When present, the cellulose fibers may have any suitable average length. The average length of the cellulose fibers may be 0.1 mm, greater than or equal to 0.2 mm, greater than or equal to 0.5 mm, greater than or equal to 1 mm, greater than or equal to 2 mm, greater than or equal to 5 mm, greater than or equal to 10 mm, greater than or equal to 15 mm, or greater than or equal to 20 mm. The average length of the cellulose fibers may be less than or equal to 25 mm, less than or equal to 20 mm, less than or equal to 15 mm, less than or equal to 10 mm, less than or equal to 5 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 25 mm, greater than or equal to 1 mm and less than or equal to 10 mm, or greater than or equal to 2 mm and less than or equal to 5 mm). Other ranges are also possible.

When present, the cellulose fibers may have any suitable Canadian Standard Freeness. The Canadian Standard Freeness of the cellulose fibers may be selected to provide a desired pore size and/or air permeability for the pasting paper. In general, lower values of Canadian Standard Freeness are correlated with smaller pore sizes and lower air permeabilities of the pasting paper or non-woven fiber web comprising the cellulose fibers, and higher values of Canadian Standard Freeness are correlated with larger pore sizes and higher air permeabilities of the pasting paper or non-woven fiber web comprising the cellulose fibers. The Canadian Standard Freeness of the cellulose fibers may be greater than or equal to 45 CSF, greater than or equal to 100 CSF, greater than or equal to 150 CSF, greater than or equal to 200 CSF, greater than or equal to 250 CSF, greater than or equal to 300 CSF, greater than or equal to 350 CSF, greater than or equal to 400 CSF, greater than or equal to 450 CSF, greater than or equal to 500 CSF, greater than or equal to 550 CSF, greater than or equal to 600 CSF, greater than or equal to 650 CSF, greater than or equal to 700 CSF, or greater than or equal to 750 CSF. The Canadian Standard Freeness of the cellulose fibers may be less than or equal to 800 CSF, less than or equal to 750 CSF, less than or equal to 700 CSF, less than or equal to 650 CSF, less than or equal to 600 CSF, less than or equal to 550 CSF, less than or equal to 500 CSF, less than or equal to 450 CSF, less than or equal to 400 CSF, less than or equal to 350 CSF, less than or equal to 300 CSF, less than or equal to 250 CSF, less than or equal to 200 CSF, less than or equal to 150 CSF, or less than or equal to 100 CSF. Combinations of the above-referenced ranges also apply (e.g., greater than or equal to 45 CSF and less than or equal to 800 CSF, greater than or equal to 300 CSF and less than or equal to 700 CSF, or greater than or equal to 550 CSF and less than or equal to 650 CSF). Other ranges are also possible. The Canadian Standard Freeness of the cellulose fibers can be measured according to a Canadian Standard Freeness test, specified by TAPPI test method T-227-OM-09 Freeness of pulp. The test can provide an average CSF value.

In some embodiments, a non-woven fiber web forming a part of a pasting paper may comprise a plurality of fibers, other than or in addition to the cellulose fibers described above, that is soluble in an electrolyte present in a battery in which a battery plate comprising the pasting paper is configured to be used, and/or decomposes upon exposure to an electrolyte present in a battery in which a battery plate comprising the pasting paper is configured to be used. As an example, a pasting paper or a non-woven fiber web may comprise a plurality of fibers comprising poly(vinyl alcohol) fibers, poly(amide) fibers, poly(acrylate) fibers, and/or poly(acrylonitrile) fibers. It should be understood this plurality of fibers, if present, may make up any suitable wt % of the pasting paper or the non-woven fiber web (e.g., a wt % of the pasting paper or the non-woven fiber web in a range described above with respect to cellulose fibers).

As described above, in certain embodiments, a fiber web or pasting paper as described herein may contain a relatively low amount of binder resin. When present, the binder resin may make up less than or equal to 10 wt %, less than or equal to 7 wt %, less than or equal to 5 wt %, less than or equal to 3 wt %, less than or equal to 2 wt %, less than or equal to 1 wt %, less than or equal to 0.5 wt %, or less than or equal to 0.2 wt % of the non-woven fiber web or the pasting paper. In some embodiments, the binder resin may make up greater than or equal to 0.1 wt %, greater than or equal to 0.2 wt %, greater than or equal to 0.5 wt %, greater than or equal to 1 wt %, greater than or equal to 2 wt %, or greater than or equal to 5 wt % of the non-woven fiber web or the pasting paper. Combinations of the above-referenced ranges are also possible (e.g., greater than or equal to 0.1 wt % and less than or equal to 10 wt % of the non-woven fiber web or the pasting paper, greater than or equal to 0.5 wt % and less than or equal to 5 wt % of the non-woven fiber web or the pasting paper, or greater than or equal to 1 wt % and less than or equal to 2 wt % of the non-woven fiber web or the pasting paper). In some embodiments, the non-woven fiber web or the pasting paper includes 0 wt % binder resin. Other ranges are also possible. The ranges above for weight percentage are based on the total weight of the non-woven fiber web or the pasting paper. For example, the binder resin may be present in an amount of greater than or equal to 0.1 wt % and less than or equal to 10 wt % of the total weight of the non-woven fiber web or the pasting paper.

When present, the binder resin may comprise any suitable materials. In some embodiments, a binder resin may comprise a polymer, such as a synthetic polymer and/or a natural polymer. Non-limiting examples of suitable synthetic polymers include fluoropolymers (e.g., poly(tetrafluoroethylene), poly(vinylidene difluoride)), styrene-butadiene, and acrylic polymers (e.g., poly(acrylic acid), poly(acrylate esters)).

When present, the binder resin may be applied to the non-woven fiber web in any suitable manner. For instance, the binder resin may be applied to the non-woven fiber web when present in a solution or in a suspension (e.g., for latex binders). The solution or suspension may further comprise water and/or an organic solvent.

In some embodiments, a pasting paper as described herein may have one or more properties (e.g., tensile strength, wicking height, mean pore size, air permeability) that are advantageous. The pasting paper may be, for example, a stand-alone pasting paper or a pasting paper combined with a battery plate or paste as described herein. The one or more properties may be present in the pasting paper prior to exposure to an electrolyte such as sulfuric acid (e.g., 1.28 spg sulfuric acid), or at any other suitable point in time (e.g., prior to incorporation into a battery, prior to battery cycling, prior to a certain number of battery cycles, at the end of battery life).

In some embodiments, the pasting paper may have a dry tensile strength in the machine direction that is greater than or equal to 0.2 lbs/in, greater than or equal to 0.5 lbs/in, greater than or equal to 1 lb/in, greater than or equal to 2 lbs/in, or greater than or equal to 3 lbs/in. The pasting paper may have a dry tensile strength in the machine direction of less than or equal to 5 lbs/in, less than or equal to 3 lbs/in, less than or equal to 2 lbs/in, less than or equal to 1 lb/in, or less than or equal to 0.5 lbs/in. Combinations of the above-referenced ranges are also possible (e.g., greater than or equal to 0.2 lbs/in and less than or equal to 5 lbs/in, greater than or equal to 0.5 lbs/in and less than or equal to 3 lbs/in, or greater than or equal to 1 lb/in and less than or equal to 2 lbs/in). Other ranges are also possible. The dry tensile strength of the pasting paper may be determined in accordance with BCIS 03A, Rev. December 2015, Method 9.

In some embodiments, a pasting paper as described herein may have a relatively large 1.28 spg sulfuric acid wicking height (e.g., prior to exposure to 1.28 spg sulfuric acid). The 1.28 spg sulfuric acid wicking height of the pasting paper (e.g., prior to exposure to 1.28 spg sulfuric acid) may be greater than or equal to 3 cm, greater than or equal to 5 cm, greater than or equal to 7 cm, greater than or equal to 10 cm, greater than or equal to 13 cm, greater than or equal to 15 cm, or greater than or equal to 17 cm. The 1.28 spg sulfuric acid wicking height of the pasting paper (e.g., prior to exposure to 1.28 spg sulfuric acid) may be less than or equal to 20 cm, less than or equal to 17 cm, less than or equal to 15 cm, less than or equal to 13 cm, less than or equal to 10 cm, less than or equal to 7 cm, or less than or equal to 5 cm. Combinations of the above-referenced ranges are also possible (e.g., greater than or equal to 3 cm and less than or equal to 20 cm, greater than or equal to 5 cm and less than or equal to 10 cm, or greater than or equal to 5 cm and less than or equal to 7 cm). Other ranges are also possible. The 1.28 spg sulfuric acid wicking height of the pasting paper (e.g., prior to exposure to 1.28 spg sulfuric acid) may be determined in accordance with ISO 8787 (1986). In ISO 8787, a pasting paper is positioned vertically in a bath of 1.28 sulfuric acid for 10 minutes. Then, the height that the 1.28 spg sulfuric acid has wicked upwards is measured.

Pasting papers as described herein may have any suitable mean pore size. In some embodiments, a pasting paper may have a mean pore size of greater than or equal to 2 microns, greater than or equal to 5 microns, greater than or equal to 10 microns, greater than or equal to 20 microns, greater than or equal to 50 microns, or greater than or equal to 70 microns. In some embodiments, a pasting paper may have a mean pore size of less than or equal to 100 microns, less than or equal to 70 microns, less than or equal to 50 microns, less than or equal to 20 microns, less than or equal to 10 microns, or less than or equal to 5 microns. Combinations of the above-referenced ranges are also possible (e.g., greater than or equal to 2 microns and less than or equal to 100 microns, greater than or equal to 5 microns and less than or equal to 70 microns, or greater than or equal to 10 microns and less than or equal to 50 microns). Other ranges are also possible. The mean pore size may be determined in accordance with the liquid porosimetry method described in BCIS-03A Rev. September 09, Method 6. This method comprises using a PMI capillary flow porometer.

Pasting papers as described herein may have any suitable air permeability. In some embodiments, a pasting paper may have an air permeability of greater than or equal to 2 CFM, greater than or equal to 5 CFM, greater than or equal to 10 CFM, greater than or equal to 20 CFM, greater than or equal to 40 CFM, greater than or equal to 80 CFM, greater than or equal to 100 CFM, greater than or equal to 150 CFM, greater than or equal to 200 CFM, greater than or equal to 250 CFM, greater than or equal to 300 CFM, greater than or equal to 400 CFM, greater than or equal to 500 CFM, greater than or equal to 750 CFM, or greater than or equal to 1000 CFM. In some embodiments, a pasting paper may have an air permeability of less than or equal to 1300 CFM, less than or equal to 1000 CFM, less than or equal to 750 CFM, less than or equal to 500 CFM, less than or equal to 400 CFM, less than or equal to 300 CFM, less than or equal to 250 CFM, less than or equal to 200 CFM, less than or equal to 150 CFM, less than or equal to 100 CFM, less than or equal to 80 CFM, less than or equal to 40 CFM, less than or equal to 20 CFM, less than or equal to 10 CFM, or less than or equal to 5 CFM. Combinations of the above-referenced ranges are also possible (e.g., greater than or equal to 2 CFM and less than or equal to 1300 CFM, greater than or equal to 20 CFM and less than or equal to 400 CFM, or greater than or equal to 40 CFM and less than or equal to 250 CFM). Other ranges are also possible. As used herein, CFM refers to cubic feet per square foot of sample area per minute (ft³/ft² min). The air permeability may be determined in accordance with ASTM Test Standard D737-96 under a pressure drop of 125 Pa on a sample with a test area of 38 cm².

Pasting papers as described herein may have any suitable specific surface area. In some embodiments, a pasting paper may have a specific surface area of greater than or equal to 0.1 m²/g, greater than or equal to 0.2 m²/g, greater than or equal to 0.3 m²/g, greater than or equal to 0.4 m²/g, greater than or equal to 0.5 m²/g, greater than or equal to 0.8 m²/g, greater than or equal to 1 m²/g, greater than or equal to 2 m²/g, greater than or equal to 5 m²/g, or greater than or equal to 8 m²/g. In some embodiments, a pasting paper may have a specific surface of less than or equal to 10 m²/g, less than or equal to 8 m²/g, less than or equal to 5 m²/g, less than or equal to 2 m²/g, less than or equal to 1 m²/g, less than or equal to 0.8 m²/g, less than or equal to 0.5 m²/g, less than or equal to 0.4 m²/g, less than or equal to 0.3 m²/g, or less than or equal to 0.2 m²/g. Combinations of the above-referenced ranges are also possible (e.g., greater than or equal to 0.1 m²/g and less than or equal to 10 m²/g, greater than or equal to 0.3 m²/g and less than or equal to 2 m²/g, or greater than or equal to 0.4 m²/g and less than or equal to 0.8 m²/g). Other ranges are also possible. The specific surface area may be determined in accordance with section 10 of Battery Council International Standard BCIS-03A (2002), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a ¾″ tube; and, the sample is allowed to degas at 75° C. for a minimum of 3 hours.

Pasting papers as described herein may have any suitable thickness. In some embodiments, a pasting paper may have a thickness of greater than or equal to 0.05 mm, greater than or equal to 0.075 mm, greater than or equal to 0.1 mm, greater than or equal to 0.12 mm, greater than or equal to 0.14 mm, greater than or equal to 0.16 mm, or greater than or equal to 0.175 mm. In some embodiments, a pasting paper may have a thickness of less than 0.2 mm, less than or equal to 0.175 mm, less than or equal to 0.16 mm, less than or equal to 0.14 mm, less than or equal to 0.12 mm, less than or equal to 0.1 mm, or less than or equal to 0.075 mm. Combinations of the above-referenced ranges are also possible (e.g., greater than or equal to 0.05 mm and less than 0.2 mm, greater than or equal to 0.1 mm and less than or equal to 0.175 mm, or greater than or equal to 0.12 mm and less than or equal to 0.16 mm). Other ranges are also possible. The thickness may be measured in accordance with BCIS-03A, September 9, Method 10 under 10 kPa applied pressure.

Pasting papers as described herein may have any suitable basis weight. In some embodiments, a pasting paper may have a basis weight of greater than or equal to 5 g/m², greater than or equal to 10 g/m², greater than or equal to 15 g/m², greater than or equal to 20 g/m², greater than or equal to 25 g/m², greater than or equal to 30 g/m², greater than or equal to 35 g/m², greater than or equal to 40 g/m², greater than or equal to 45 g/m², greater than or equal to 50 g/m², greater than or equal to 60 g/m², greater than or equal to 70 g/m², greater than or equal to 80 g/m², or greater than or equal to 90 g/m². In some embodiments, a pasting paper may have a basis weight of less than or equal to 100 g/m², less than or equal to 90 g/m², less than or equal to 80 g/m², less than or equal to 70 g/m², less than or equal to 60 g/m², less than or equal to 50 g/m², less than or equal to 45 g/m², less than or equal to 40 g/m², less than or equal to 35 g/m², less than or equal to 30 g/m², less than or equal to 25 g/m², less than or equal to 20 g/m², less than or equal to 15 g/m², or less than or equal to 10 g/m². Combinations of the above-referenced ranges are also possible (e.g., greater than or equal to 5 g/m² and less than or equal to 100 g/m², greater than or equal to 20 g/m² and less than or equal to 40 g/m², or greater than or equal to 25 g/m² and less than or equal to 35 g/m²). Other ranges are also possible. The basis weight may be determined in accordance with BCIS-03A, September 9, Method 3.

Pasting papers as described herein may have any suitable electrical resistance. In some embodiments, a pasting paper may have an electrical resistance of greater than or equal to 5 milliΩ·cm², greater than or equal to 10 milliΩ·cm², greater than or equal to 20 milliΩ·cm², greater than or equal to 30 milliΩ·cm², greater than or equal to 50 milliΩ·cm², or greater than or equal to 75 milliΩ·cm². In some embodiments, a pasting paper may have an electrical resistance of less than or equal to 100 milliΩ·cm², less than or equal to 75 milliΩ·cm², less than or equal to 50 milliΩ·cm², less than or equal to 30 milliΩ·cm², less than or equal to 20 milliΩ·cm², or less than or equal to 10 milliΩ·cm². Combinations of the above-referenced ranges are also possible (e.g., greater than or equal to 5 milliΩ·cm² and less than or equal to 100 milliΩ·cm², greater than or equal to 5 milliΩ·cm² and less than or equal to 50 milliΩ·cm², or greater than or equal to 5 milliΩ·cm² and less than or equal to 30 milliΩ·cm²). Other ranges are also possible. The electrical resistance may be determined in accordance by performing BCIS-03B (2002), method 18 and omitting the pretreatment or conditioning step.

As described above, certain pasting papers described herein may be configured such that at least a portion of the pasting paper dissolves upon exposure to an electrolyte, such as upon exposure to sulfuric acid (e.g., at a concentration of 1.28 spg). Some properties of such pasting papers may be different prior to exposure to the electrolyte than after exposure to the electrolyte for a certain period of time.

For instance, in some embodiments, at least a portion of the pasting paper and/or the non-woven fiber web may dissolve upon exposure to an electrolyte (e.g., sulfuric acid, such as 1.28 spg sulfuric acid). In certain cases, a pasting paper and/or a non-woven fiber web may comprise a plurality of cellulose fibers, and at least a portion of the cellulose fibers may dissolve upon exposure to an electrolyte (e.g., sulfuric acid, such as 1.28 spg sulfuric acid). The pasting paper or non-woven fiber web may be configured such that greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, or greater than or equal to 70 wt % of the cellulose fibers dissolve after storage in 1.28 spg sulfuric acid at 75° C. for 7 days. The pasting paper or non-woven fiber web may be configured such that less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % of the cellulose fibers dissolve after storage in 1.28 spg sulfuric acid at 75° C. for 7 days. Combinations of the above-referenced ranges are also possible (e.g., greater than or equal to 0 wt % and less than or equal to 80 wt %). Other ranges are also possible.

In some embodiments, a pasting paper may have a relatively high dry tensile strength after exposure to 1.28 spg sulfuric acid. The pasting paper may be configured to have a dry tensile strength after storage in 1.28 spg sulfuric acid at 75° C. for 7 days of greater than or equal to 0.2 lbs/in, greater than or equal to 0.5 lbs/in, greater than or equal to 1 lb/in, greater than or equal to 2 lbs/in, greater than or equal to 3 lbs/in, greater than or equal to 4 lbs/in, greater than or equal to 5 lbs/in, or greater than or equal to 7 lbs/in. The pasting paper may be configured to have a dry tensile strength after storage in 1.28 spg sulfuric acid at 75° C. for 7 days of less than or equal to 10 lbs/in, less than or equal to 7 lbs/in, less than or equal to 5 lbs/in, less than or equal to 4 lbs/in, less than or equal to 3 lbs/in, less than or equal to 2 lbs/in, less than or equal to 1 lb/in, or less than or equal to 0.5 lbs/in. Combinations of the above-referenced ranges are also possible (e.g., greater than or equal to 0.2 lbs/in and less than or equal to 10 lbs/in, greater than or equal to 1 lb/in and less than or equal to 10 lbs/in, greater than or equal to 0.5 lbs/in and less than or equal to 5 lbs/in, greater than or equal to 1 lb/in and less than or equal to 5 lbs/in, greater than or equal to 1 lb/in and less than or equal to 3 lbs/in, or greater than or equal to 1 lb/in and less than or equal to 2 lbs/in). Other ranges are also possible. The dry tensile strength of the pasting paper may be determined in accordance with BCIS 03A, Rev. December 2015, Method 9.

In some embodiments, the dry tensile strength of a pasting paper may change relatively little after exposure to 1.28 spg sulfuric acid. The pasting paper may be configured to have a dry tensile strength after storage in 1.28 spg sulfuric acid at 75° C. for 7 days that is within 40%, within 35%, within 30%, within 25%, within 20%, within 15%, within 10%, within 5%, within 2%, or within 1% of its dry tensile strength at the point in time when it has its maximum dry tensile strength (e.g., after fabrication, prior to exposure to sulfuric acid).

In some embodiments, a pasting paper as described herein may be configured to have a mean pore size after exposure to 1.28 spg sulfuric acid that is larger than its mean pore size prior to exposure to 1.28 spg sulfuric acid. The pasting paper may be configured to have a mean pore size after storage in 1.28 spg sulfuric acid at 75° C. for 7 days of greater than or equal to 2 microns, greater than or equal to 5 microns, greater than or equal to 10 microns, greater than or equal to 20 microns, greater than or equal to 50 microns, greater than or equal to 100 microns, greater or equal to 150 microns, greater than or equal to 200 microns, or greater than or equal to 250 microns. The pasting paper may be configured to have a mean pore size after storage in 1.28 spg sulfuric acid at 75° C. for 7 days of less than or equal to 300 microns, less than or equal to 250 microns, less than or equal to 200 microns, less than or equal to 150 microns, less than or equal to 100 microns, less than or equal to 50 microns, less than or equal to 20 microns, less than or equal to 10 microns, less than or equal to 5 microns, or less than or equal to 2 microns. Combinations of the above-referenced ranges are also possible (e.g., greater than or equal to 2 microns and less than or equal to 300 microns, greater than or equal to 5 microns and less than or equal to 200 microns, or greater than or equal to 10 microns and less than or equal to 150 microns). Other ranges are also possible. The mean pore size may be determined in accordance with the liquid porosimetry method described in BCIS-03A Rev. September 09, Method 6. This method comprises using a PMI capillary flow porometer.

The mean pore size of a pasting paper may change by any appropriate amount after exposure to 1.28 spg sulfuric acid. The pasting paper may be configured to have a mean pore size after storage in 1.28 spg sulfuric acid at 75° C. for 7 days that is greater than or equal to 0% larger, greater than or equal to 1% larger, greater than or equal to 2% larger, greater than or equal to 5% larger, greater than or equal to 10% larger, greater than or equal to 25% larger, greater than or equal to 50% larger, greater than or equal to 100% larger, or greater than or equal to 200% larger than its mean pore size at another point in time (e.g., after fabrication, prior to exposure to sulfuric acid). The pasting paper may be configured to have a mean pore size after storage in 1.28 spg sulfuric acid at 75° C. for 7 days that is less than or equal to 300% larger, less than or equal to 200% larger, less than or equal to 100% larger, less than or equal to 50% larger, less than or equal to 25% larger, less than or equal to 10% larger, less than or equal to 5% larger, less than or equal to 2% larger, or less than or equal to 1% larger than its mean pore size at another point in time (e.g., after fabrication, prior to exposure to sulfuric acid). Combinations of the above-referenced ranges are also possible (e.g., greater than or equal to 0% larger and less than or equal to 300% larger). Other ranges are also possible.

In some embodiments, a pasting paper as described herein may be configured to have an air permeability after exposure to 1.28 spg sulfuric acid that is larger than its air permeability prior to exposure to 1.28 spg sulfuric acid. The pasting paper may be configured to have an air permeability after storage in 1.28 spg sulfuric acid at 75° C. for 7 days of greater than or equal to 100 CFM, greater than or equal to 200 CFM, greater than or equal to 300 CFM, greater than or equal to 500 CFM, greater than or equal to 750 CFM, or greater than or equal to 1000 CFM. The pasting paper may be configured to have an air permeability after storage in 1.28 spg sulfuric acid at 75° C. for 7 days of less than or equal to 1300 CFM, less than or equal to 1000 CFM, less than or equal to 750 CFM, less than or equal to 500 CFM, less than or equal to 300 CFM, or less than or equal to 200 CFM. Combinations of the above-referenced ranges are also possible (e.g., greater than or equal to 100 CFM and less than or equal to 1300 CFM, greater than or equal to 200 CFM and less than or equal to 1300 CFM, or greater than or equal to 300 CFM and less than or equal to 1000 CFM). Other ranges are also possible. As used herein, CFM refers to cubic feet per square foot of sample area per minute (ft³/ft² min). The air permeability may be determined in accordance with ASTM Test Standard D737-96 under a pressure drop of 125 Pa on a sample with a test area of 38 cm².

The air permeability of a pasting paper may change by any appropriate amount after exposure to 1.28 spg sulfuric acid. The pasting paper may be configured to have an air permeability after storage in 1.28 spg sulfuric acid at 75° C. for 7 days that is greater than or equal to 0% larger, greater than or equal to 1% larger, greater than or equal to 2% larger, greater than or equal to 5% larger, greater than or equal to 10% larger, greater than or equal to 25% larger, greater than or equal to 50% larger, greater than or equal to 100% larger, greater than or equal to 200% larger, greater than or equal to 300% larger, greater than or equal to 400% larger, greater than or equal to 500% larger, or greater than or equal to 750% than its air permeability size at another point in time (e.g., after fabrication, prior to exposure to sulfuric acid). The pasting paper may be configured to have an air permeability after storage in 1.28 spg sulfuric acid at 75° C. for 7 days that is less than or equal to 1000% larger, less than or equal to 750% larger, less than or equal to 500% larger, less than or equal to 400% larger, less than or equal to 300% larger, less than or equal to 200% larger, less than or equal to 100% larger, less than or equal to 50% larger, less than or equal to 25% larger, less than or equal to 10% larger, less than or equal to 5% larger, less than or equal to 2% larger, or less than or equal to 1% larger than its air permeability size at another point in time (e.g., after fabrication, prior to exposure to sulfuric acid). Combinations of the above-referenced ranges are also possible (e.g., greater than or equal to 0% larger and less than or equal to 1000% larger). Other ranges are also possible.

As described above, in some embodiments the pasting papers described herein may be suitable for lead-acid batteries. However, the pasting papers may also be used for other battery types and references to lead-acid batteries herein should be understood not to be limiting. Lead-acid batteries typically comprise a first battery plate (e.g., a negative battery plate) that comprises lead and a second battery plate (e.g., a positive battery plate) that comprises lead dioxide. During discharge, electrons pass from the first battery plate to the second battery plate while the lead paste in the first battery plate is oxidized to form lead sulfate and the lead dioxide in the second battery plate is reduced to also form lead sulfate. During charge, electrons pass from the second battery plate to the first battery plate while the lead sulfate in the first battery plate is reduced to form lead and the lead sulfate in the second battery plate is oxidized to form lead dioxide. Pasting papers as described herein may be suitable for use on positive battery plates and/or negative battery plates.

In some embodiments, a pasting paper as described herein may be disposed on a battery plate for use in a valve regulated lead-acid battery (VRLA) battery, such as an AGM/VRLA battery, (and/or may be present in a VRLA battery such as an AGM/VRLA battery), or may be disposed on a battery plate for use in a VRLA/Gel battery (and/or may be present in a VRLA/Gel battery). VRLA batteries are lead-acid batteries that comprise a valve configured to vent one or more gases from the battery. These gases may include gases that form as a result of electrolyte decomposition during overcharging, such as hydrogen gas and/or oxygen gas. It may be desirable to maintain the gases in the battery so that they may recombine, reducing or eliminating the need to replenish the decomposed electrolyte. However, it may also be desirable to maintain the pressure inside the battery at a safe level. For these reasons, the valve may be configured to vent the gas(es) under some circumstances, such as when the pressure inside the battery is above a threshold value, but not in others, such as when the pressure inside the battery is below the threshold value.

It should be noted that pasting papers described herein may, in some embodiments, be disposed on battery plates configured to be used with (and/or battery plates positioned in) other types of lead-acid batteries. For instance, a pasting paper may be disposed on a battery plate for use in a conventional flooded battery (and/or may be present in a conventional flooded battery), and/or may be disposed on a battery plate for use in an enhanced flooded battery (an EFB) (and/or may be present in an EFB battery).

Battery plates described herein (e.g., battery plates on which pasting papers are disposed, first battery plates, negative battery plates, second battery plates, positive battery plates) typically comprise a battery paste disposed on a grid. A battery paste included in a first battery plate (e.g., a negative battery plate) may comprise lead, and/or may comprise both lead and lead dioxide (e.g., prior to full charging, during fabrication, battery assembly, and/or during one or more portions of a method described herein). A battery paste included in a second battery plate (e.g., a positive battery plate), may comprise lead dioxide, and/or may comprise both lead and lead dioxide (e.g., prior to full charging, during fabrication, battery assembly, and/or during one or more portions of a method described herein). Grids (e.g., a grid included in a first battery plate, a grid included in a negative battery plate, a grid included in a second battery plate, a grid included in a positive battery plate), in some embodiments, include lead and/or a lead alloy.

In some embodiments, one or more battery plates (e.g., battery plates on which pasting papers are disposed, first battery plates, negative battery plates, second battery plates, positive battery plates) may further comprise one or more additional components. For instance, a battery plate may comprise a reinforcing material, such as an expander. When present, an expander may comprise barium sulfate, carbon black and lignin sulfonate as the primary components. The components of the expander(s) (e.g., carbon black and/or lignin sulfonate, if present, and/or any other components) can be pre-mixed or not pre-mixed. In some embodiments, a battery plate may comprise a commercially available expander, such as an expander produced by Hammond Lead Products (Hammond, Ind.) (e.g., a Texex® expander) or an expander produced by Atomized Products Group, Inc. (Garland, Tex.). Further examples of reinforcing materials include chopped organic fibers (e.g., having an average length of 0.125 inch or more), chopped glass fibers, metal sulfate(s) (e.g., nickel sulfate, copper sulfate), red lead (e.g., a Pb₃O₄-containing material), litharge, and paraffin oil.

It should be understood that while the additional components described above may be present in any combination of battery plates in a battery (e.g., in a first or negative battery plate and a second or positive battery plate, in a first or negative battery plate but not a second or positive battery plate, in a second or positive battery plate but not a first or negative battery plate, in no battery plates), certain additional components may be especially advantageous for some types of battery plates. For instance, expanders, metal sulfates, and parafins may be especially advantageous for use in second or positive battery plates. One or more of these components may be present in a second or positive battery plate, and absent in a first or negative battery plates. Some additional components described above may have utility in many types of battery plates (e.g., first battery plates, negative battery plates, second battery plates, positive battery plates). Non-limiting examples of such components include fibers (e.g., chopped organic fibers, chopped glass fibers). These components may, in some embodiments, be present in both first and second battery plates, and/or be present in both negative and positive battery plates.

In some embodiments, a battery comprising a battery plate on which a pasting paper as described herein is disposed may further comprise a separator. The separator may be positioned between a negative battery plate and a positive battery plate therein to prevent electronic short circuiting. Non-limiting examples of suitable separators include non-woven glass separators (e.g., absorptive glass mat (AGM) separators), poly(ethylene) separators, separators comprising a phenol resin, leaf separators, envelope separators (i.e., separators sealed on three sides), z-fold separators, sleeve separators, corrugated separators, C-wrap separators, U-wrap separators, etc. The separator, if present, may be infiltrated by an electrolyte, such as sulfuric acid (e.g., at 1.28 spg), which promotes ion transport between the two battery plates during discharge and charge.

Non-woven fiber webs and pasting papers described herein may be produced using suitable processes, such as a wet laid process. In general, a wet laid process involves mixing together fibers of one or more type; for example, a plurality of glass fibers may be mixed together with a plurality of multicomponent fibers and a plurality of cellulose fibers to provide a fiber slurry. The slurry may be, for example, an aqueous-based slurry. In certain embodiments, fibers are optionally stored separately, or in combination, in various holding tanks prior to being mixed together.

For instance, each plurality of fibers or fiber type may be mixed and pulped together in separate containers. As an example, a plurality of glass fibers may be mixed and pulped together in one container, a plurality of multicomponent fibers may be mixed and pulped in a second container, and a plurality of cellulose fibers may be mixed and pulped in a third container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture. Furthermore, it should be appreciated that other combinations of fibers types may be used in fiber mixtures, such as the fiber types described herein.

In certain embodiments, a non-woven fiber web may be formed by a wet laid process. For example, in some embodiments, a single dispersion (e.g., a pulp) in a solvent (e.g., an aqueous solvent such as water) or slurry can be applied onto a wire conveyor in a papermaking machine (e.g., a fourdrinier or a rotoformer) to form a single layer supported by the wire conveyor. Vacuum may be continuously applied to the dispersion of fibers during the above process to remove the solvent from the fibers, thereby resulting in an article containing the single layer.

In some embodiments, multiple layers may be formed simultaneously or sequentially in a wet laid process. For instance, a first layer may be formed as described above, and then one or more layers may be formed on the first layer by following the same procedure. As an example, a dispersion in a solvent or slurry may be applied to a first layer on a wire conveyor, and vacuum applied to the dispersion or slurry to form a second layer on the first layer. Further layers may be formed on the first layer and the second layer by following this same process.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet laid process uses similar equipment as in a conventional papermaking process, for example, a hydropulper, a former or a headbox, a dryer, and an optional converter. A non-woven fiber web or pasting paper can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

In some cases, the pH of the fiber slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

After formation of a pasting paper, it may be incorporated into a battery plate. For instance, the pasting paper may be disposed on a battery plate. Battery plates for lead-acid batteries are typically formed by positioning a battery paste comprising lead and/or lead dioxide on a metal grid. After a battery plate is formed, the pasting paper may then be positioned on (and, optionally, at least partially embedded in) the battery paste therein. Then, the pasting-paper covered battery plate may undergo further manufacturing steps, such as being cut to form plates appropriately sized for inclusion in a battery, and/or being cured in an oven.

Once ready for inclusion in a final battery, the pasting-paper covered battery plate may be assembled with other battery components, such as an additional battery plate (e.g., a negative battery plate may be assembled with a positive battery plate), a separator, etc. These components may be placed in an external casing, and, optionally compressed. If compressed, the thickness of one or more battery components (e.g., a pasting paper disposed on a battery plate) may be reduced. Then, an electrolyte, such as 1.28 spg sulfuric acid, may be added to the battery.

After assembly, the battery may undergo a formation step, during which the battery becomes fully charged and ready for operation. Formation may involve passing an electric current through an assembly of alternating negative and positive battery plates separated by separators. During formation, the battery paste in the negative and positive battery plates may be converted into negative and positive active materials, respectively. For example, lead dioxide in a battery paste disposed on the negative battery plate may be transformed into lead dioxide, and/or lead in a battery paste disposed on the positive battery plate may be transformed into lead dioxide.

When present, a plurality of cellulose fibers in a pasting paper may dissolve in an electrolyte over any suitable period of time after the addition of the electrolyte to the battery. For instance, at least a portion of the plurality of cellulose fibers, or all of the plurality of cellulose fibers, may be dissolved in the electrolyte prior to formation. In some embodiments, at least a portion of a plurality of cellulose fibers, or all of the plurality of cellulose fibers, dissolve in the electrolyte during formation. In some embodiments, at least a portion of the plurality of cellulose fibers, or all of the plurality of cellulose fibers, may be dissolved in the electrolyte after formation.

Paragraph 1: In some embodiments, a lead-acid battery is provided. The lead-acid battery comprises a battery plate comprising lead and a pasting paper disposed on the battery plate. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron.

Paragraph 2: In some embodiments, a lead-acid battery comprises a battery plate comprising lead and a pasting paper disposed on the battery plate. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % of the non-woven fiber web based on the total weight of the non-woven fiber web.

Paragraph 3: In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % and less than or equal to 80 wt % of the non-woven fiber web based on the total weight of the non-woven fiber web. The plurality of multicomponent fibers makes up greater than or equal to 10 wt % and less than or equal to 50 wt % of the non-woven fiber web based on the total weight of the non-woven fiber web. The plurality of glass fibers makes up greater than or equal to 10 wt % and less than or equal to 50 wt % of the non-woven fiber web based on the total weight of the non-woven fiber web. In some cases, the pasting paper has a thickness of less than 0.2 mm.

Paragraph 4: In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The pasting paper has a thickness of less than 0.2 mm, an air permeability of less than or equal to 300 CFM, a 1.28 spg sulfuric acid wicking height of greater than or equal to 3 cm, and/or is configured to have a dry tensile strength in a machine direction of greater than or equal to 1 lb/in after storage in 1.28 spg sulfuric acid at 75° C. for 7 days.

Paragraph 5: In some embodiments, methods of forming battery plates are provided. A method of forming a battery plate comprises disposing a pasting paper on a battery paste comprising lead. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron.

Paragraph 6: In some embodiments, a method of forming a battery plate comprises disposing a pasting paper on a battery paste comprising lead. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

Paragraph 7: In some embodiments, methods of assembling lead-acid batteries are provided. A method of assembling a lead-acid battery comprises assembling a first battery plate comprising lead with a separator and a second battery plate to form a lead-acid battery. A pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron.

Paragraph 8: In some embodiments, a method of assembling a lead-acid battery comprises assembling a first battery plate comprising lead with a separator and a second battery plate to form a lead-acid battery. A pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

Paragraph 9: In some embodiments, methods of forming lead-acid batteries are provided. A method of forming a lead-acid battery comprises assembling a first battery plate comprising lead with a separator, an electrolyte, and a second battery plate to form a lead-acid battery. The pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The method further comprises dissolving at least a portion of the plurality of cellulose fibers within the pasting paper in the electrolyte.

Paragraph 10: In some embodiments, a method of forming a lead-acid battery comprises assembling a first battery plate comprising lead with a separator, an electrolyte, and a second battery plate to form a lead-acid battery. The pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web. The method further comprises dissolving at least a portion of the plurality of cellulose fibers within the pasting paper in the electrolyte.

Paragraph 11: In some embodiments, a pasting paper described in any one of paragraphs 1-10 has an air permeability of less than or equal to 300 CFM (e.g., an air permeability of greater than or equal to 2 CFM and less than or equal to 1300 CFM, an air permeability of greater than or equal to 20 CFM and less than or equal to 400 CFM, an air permeability of greater than or equal to 40 CFM and less than or equal to 250 CFM).

Paragraph 12: In some embodiments, a pasting paper described in any one of paragraphs 1-11 has a 1.28 spg sulfuric acid wicking height of greater than or equal to 3 cm (e.g., a 1.28 spg sulfuric acid wicking height of greater than or equal to 3 cm and less than or equal to 20 cm, a 1.28 spg sulfuric acid wicking height of greater than or equal to 5 cm and less than or equal to 10 cm, a 1.28 spg sulfuric acid wicking height of greater than or equal to 5 cm and less than or equal to 7 cm).

Paragraph 13: In some embodiments, a pasting paper described in any one of paragraphs 1-12 is configured to have a dry tensile strength in a machine direction of greater than or equal to 1 lb/in after storage in 1.28 spg sulfuric acid at 75° C. for 7 days (e.g., a dry tensile strength in a machine direction of greater than or equal to 0.2 lbs/in and less than or equal to 10 lb/in after storage in 1.28 spg sulfuric acid at 75° C. for 7 days, a dry tensile strength in a machine direction of greater than or equal to 1 lb/in and less than or equal to 10 lbs/in after storage in 1.28 spg sulfuric acid at 75° C. for 7 days, a dry tensile strength in a machine direction of greater than or equal to 0.5 lbs/in and less than or equal to 5 lbs/in after storage in 1.28 spg sulfuric acid at 75° C. for 7 days, a dry tensile strength in a machine direction of greater than or equal to 1 lb/in and less than or equal to 5 lbs/in after storage in 1.28 spg sulfuric acid at 75° C. for 7 days, a dry tensile strength in a machine direction of greater than or equal to 1 lb/in and less than or equal to 3 lbs/in after storage in 1.28 spg sulfuric acid at 75° C. for 7 days, a dry tensile strength in a machine direction of greater than or equal to 1 lb/in and less than or equal to 2 lbs/in after storage in 1.28 spg sulfuric acid at 75° C. for 7 days).

Paragraph 14: In some embodiments, a pasting paper as described in any one of paragraphs 1-13 has a composition such that a binder resin makes up less than or equal to 10 wt %, less than or equal to 5 wt %, or less than or equal to 2 wt % of the pasting paper based on the total weight of the pasting paper.

Paragraph 15: In some embodiments, a plurality of cellulose fibers as described in any one of paragraphs 1-14 comprises fibrillated cellulose fibers.

Paragraph 16: In some embodiments, a plurality of cellulose fibers as described in any one of paragraphs 1-15 has a Canadian Standard Freeness of greater than or equal to 45 CSF and less than or equal to 800 CSF (e.g., a Canadian Standard Freeness of greater than or equal to 45 CSF and less than or equal to 800 CSF, a Canadian Standard Freeness of greater than or equal to 300 CSF and less than or equal to 700 CSF, a Canadian Standard Freeness of greater than or equal to 550 CSF and less than or equal to 650 CSF).

Paragraph 17: In some embodiments, a plurality of glass fibers as described in any one of paragraphs 1-16 comprises microglass fibers.

Paragraph 18: In some embodiments, a plurality of glass fibers as described in any one of paragraphs 1-17 comprises chopped strand glass fibers.

Paragraph 19: In some embodiments, a pasting paper as described in any one of paragraphs 1-18 has a mean pore size of greater than or equal to 2 microns and less than or equal to 100 microns (e.g., a mean pore size of greater than or equal to 5 microns and less than or equal to 70 microns, a mean pore size of greater than or equal to 10 microns and less than or equal to 50 microns).

Paragraph 20: In some embodiments, a pasting paper as described in any one of paragraphs 1-19 has a specific surface area of greater than or equal to 0.1 m²/g and less than or equal to 10 m²/g (e.g., a specific surface area of greater than or equal to 0.3 m²/g and less than or equal to 2 m²/g, a specific surface area of greater than or equal to 0.4 m²/g and less than or equal to 0.8 m²/g).

Paragraph 21: In some embodiments, a pasting paper as described in any one of paragraphs 1-20 is configured to have a mean pore size of greater than or equal to 2 microns and less than or equal to 300 microns after storage in 1.28 spg sulfuric acid at 75° C. for 7 days (e.g., a mean pore size of greater than or equal to 5 microns and less than or equal to 200 microns after storage in 1.28 spg sulfuric acid at 75° C. for 7 days, a mean pore size of greater than or equal to 10 microns and less than or equal to 150 microns after storage in 1.28 spg sulfuric acid at 75° C. for 7 days).

Paragraph 22: In some embodiments, a pasting paper as described in any one of paragraphs 1-21 is configured to have an air permeability of greater than or equal to 100 CFM and less than or equal to 1300 CFM after storage in 1.28 spg sulfuric acid at 75° C. for 7 days (e.g., an air permeability of greater than or equal to 200 CFM and less than or equal to 1300 CFM after storage in 1.28 spg sulfuric acid at 75° C. for 7 days, an air permeability of greater than or equal to 300 CFM and less than or equal to 1000 CFM after storage in 1.28 spg sulfuric acid at 75° C. for 7 days).

Paragraph 23: In some embodiments, a pasting paper as described in any one of paragraphs 1-22 has an electrical resistance of greater than or equal to 5 milliΩ·cm² and less than or equal to 100 milliΩ·cm² (e.g., an electrical resistance of greater than or equal to 5 milliΩ·cm² and less than or equal to 50 milliΩ·cm², an electrical resistance of greater than or equal to 5 milliΩ·cm² and less than or equal to 30 milliΩ·cm²).

Paragraph 24: In some embodiments, a method as described in any one of paragraphs 1-23 further comprises positioning the battery plate in a battery.

Paragraph 25: In some embodiments, a method as described in any one of paragraphs 1-24 further comprises exposing the battery plate to an electrolyte.

Paragraph 26: In some embodiments, an electrolyte as described in any one of paragraphs 1-25 comprises sulfuric acid (e.g., the electrolyte comprises 1.28 spg sulfuric acid).

Paragraph 27: In some embodiments, upon exposure of a battery plate described in any one of paragraphs 1-26 to the electrolyte, at least a portion of the pasting paper dissolves in the electrolyte.

Paragraph 28: In some embodiments, after dissolution of at least a portion of a pasting paper as described in any one of paragraphs 1-27 in the electrolyte, the non-woven fiber web is a porous non-woven fiber web comprising the plurality of glass fibers and the plurality of multicomponent fibers.

Paragraph 29: In some embodiments, after dissolution of at least a portion of a pasting paper described in any one of paragraphs 1-28 in the electrolyte, a mean pore size of the pasting paper is greater than a mean pore size of the pasting paper prior to dissolution of at least a portion of the pasting paper in the electrolyte.

Paragraph 30: In some embodiments, after dissolution of at least a portion of the pasting paper in the electrolyte, an air permeability of a pasting paper described in any one of paragraphs 1-29 is greater than an air permeability of the pasting paper prior to dissolution of at least a portion of the pasting paper in the electrolyte.

### Example 1

This Example describes a comparison between certain pasting papers comprising glass fibers, bicomponent fibers, and cellulose fibers with other pasting papers lacking two of these types of fibers.

Three pasting papers were prepared by wet laid forming. Each pasting paper included cellulose fibers, bicomponent fibers, and glass fibers. The bicomponent fibers were 1.3 Dtex PET/PE that were 6 mm long. The glass fibers included chopped strand glass fibers with an average fiber diameter of 13.5 microns and a length of 12 mm and/or microglass fibers with an average fiber diameter of 1.3 microns. These pasting papers were compared to two commercially available pasting papers, one of which lacked bicomponent fibers and glass fibers, and the other of which lacked bicomponent fibers and cellulose fibers. The basis weight, thickness, air permeability, and 1.28 spg sulfuric acid wicking height were determined for each pasting paper in accordance with the methods described above. Then, the pasting papers were stored in 1.28 spg sulfuric acid for 7 days at 75° C. After 1.28 spg sulfuric acid storage, the pasting papers were removed from the 1.28 spg sulfuric acid, washed with water, and then dried. The pasting papers were visually examined to determine whether they retained their structural integrity, and their machine direction dry tensile strengths were measured in accordance with the method described above. Table 1, below, shows the composition of each sample, and the results of the measurements performed thereon.

TABLE 1

| | | Dura-Glass ™ | | | |
|---|---|---|---|---|---|
| | DynaGrid ™ | PR-9 | Sample 1 | Sample 2 | Sample 3 |
| Wt % | 100 | 0 | 50 | 50 | 50 |
| cellulose | | | | | |
| fibers | | | | | |
| Wt % | 0 | 0 | 30 | 30 | 25 |
| bicomponent | | | | | |
| fibers | | | | | |
| Wt % chopped | 0 | 66 | 20 | 0 | 15 |
| strand glass | | | | | |
| fibers | | | | | |
| Wt % | 0 | 0 | 0 | 20 | 10 |
| microglass | | | | | |
| fibers | | | | | |
| Wt % binder | 0 | 34 | 0 | 0 | 0 |
| resin | | | | | |
| Basis weight | 13.4 | 20.2 | 30.9 | 26.4 | 28.1 |
| (g/m²) | | | | | |
| Thickness | 0.054 | 0.159 | 0.125 | 0.120 | 0.121 |
| (mm) | | | | | |
| Air | 272 | 1363 | 107 | 29 | 12 |
| permeability | | | | | |
| (CFM) | | | | | |
| 1.28 spg | 25 | 0.0 | 7.0 | 6.0 | 7.5 |
| sulfuric acid | | | | | |
| wicking | | | | | |
| height in (cm) | | | | | |
| Structural | Disintegrated | Structural | Structural | Structural | Structural |
| integrity after | (after two | integrity | integrity | integrity | integrity |
| storage in | hours) | retained | retained | retained | retained |
| 1.28 spg | | | | | |
| sulfuric acid | | | | | |
| Dry tensile | N/A | 2.7 | 2.2 | 1.7 | 1.5 |
| strength after | | | | | |
| storage in | | | | | |
| 1.28 spg | | | | | |
| sulfuric acid | | | | | |
| (lb/in) | | | | | |

As shown in Table 1, pasting papers comprising a glass fibers, bicomponent fibers, and cellulose fibers (Samples 1-3) had beneficial properties both initially and after storage in 1.28 spg sulfuric acid. These pasting papers had initial values of air permeability that were low enough to prevent lead particles and/or lead dioxide particles in a battery plate from migrating through the pasting paper, wicking heights showing appreciable wettability of the pasting paper, and sufficient tensile strength after storage in 1.28 spg sulfuric acid to reduce lead shedding through the pasting paper. By contrast, both the pasting paper lacking glass fibers and bicomponent fibers (DynaGrid™) and the pasting paper lacking cellulose fibers and bicomponent fibers (Dura-Glass™ PR-9) had one or more disadvantageous properties. The pasting paper lacking glass fibers and bicomponent fibers disintegrated quickly in the 1.28 spg sulfuric acid, rendering it unsuitable for preventing lead shedding when present in a battery with a 1.28 spg sulfuric acid electrolyte. The pasting paper lacking cellulose fibers and bicomponent fibers had an incredibly high air permeability, which would result in unacceptably high lead particle and lead dioxide particle transport through the pasting paper, and a wicking height of 0 cm, rendering it undesirable for use in a battery with a 1.28 spg sulfuric acid electrolyte. The pasting papers comprising glass fibers, bicomponent fibers, and cellulose fibers thus outperformed pasting papers lacking at least two of these fiber types.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A lead-acid battery, comprising:
a battery plate comprising lead; and
a pasting paper disposed on the battery plate, wherein the pasting paper comprises a non-woven fiber web comprising:
a plurality of cellulose fibers, wherein the plurality of cellulose fibers has an average fiber diameter of greater than or equal to 1 micron, and wherein the plurality of cellulose fibers makes up greater than or equal to 20 wt % of the non-woven fiber web based on the total weight of the non-woven fiber web;
a plurality of multicomponent fibers, wherein the plurality of multicomponent fibers has an average fiber diameter of greater than or equal to 1 micron; and
a plurality of glass fibers, wherein the plurality of glass fibers has an average fiber diameter of greater than or equal to 1 micron.

2. A pasting paper for use in a battery, comprising:
a non-woven fiber web, comprising:
a plurality of cellulose fibers, wherein the plurality of cellulose fibers makes up greater than or equal to 20 wt % and less than or equal to 80 wt % of the non-woven fiber web based on the total weight of the non-woven fiber web, and wherein the plurality of cellulose fibers has an average fiber diameter of greater than or equal to 1 micron;
a plurality of multicomponent fibers, wherein the plurality of multicomponent fibers makes up greater than or equal to 10 wt % and less than or equal to 50 wt % of the non-woven fiber web based on the total weight of the non-woven fiber web, and wherein the plurality of multicomponent fibers has an average fiber diameter of greater than or equal to 1 micron; and
a plurality of glass fibers, wherein the plurality of glass fibers makes up greater than or equal to 10 wt % and less than or equal to 50 wt % of the non-woven fiber web based on the total weight of the non-woven fiber web, and wherein the plurality of glass fibers has an average fiber diameter of greater than or equal to 1 micron,
wherein the pasting paper has a thickness of less than 0.2 mm.

3. A pasting paper for use in a battery, comprising:
a non-woven fiber web, comprising:
a plurality of cellulose fibers, wherein the plurality of cellulose fibers has an average fiber diameter of greater than or equal to 1 micron;
a plurality of multicomponent fibers, wherein the plurality of multicomponent fibers has an average fiber diameter of greater than or equal to 1 micron; and
a plurality of glass fibers, wherein the plurality of glass fibers has an average fiber diameter of greater than or equal to 1 micron,
wherein the pasting paper has a thickness of less than 0.2 mm,
wherein the pasting paper has an air permeability of less than or equal to 300 CFM,
wherein the pasting paper has a 1.28 spg sulfuric acid wicking height of greater than or equal to 3 cm, and
wherein the pasting paper is configured to have a dry tensile strength in a machine direction of greater than or equal to 1 lb/in after storage in 1.28 spg sulfuric acid at 75° C. for 7 days.

4-6. (canceled)

7. A pasting paper as in claim 2, wherein the pasting paper has an air permeability of less than or equal to 300 CFM.

8. A pasting paper as in claim 2, wherein the pasting paper has a 1.28 spg sulfuric acid wicking height of greater than or equal to 3 cm.

9. A pasting paper as in claim 2, wherein the pasting paper is configured to have a dry tensile strength in a machine direction of greater than or equal to 1 lb/in after storage in 1.28 spg sulfuric acid at 75° C. for 7 days.

10. A pasting paper as in claim 2, wherein a binder resin makes up less than or equal to 10 wt % of the pasting paper based on the total weight of the pasting paper.

11. A pasting paper as in claim 2, wherein the plurality of cellulose fibers comprises fibrillated cellulose fibers.

12. A pasting paper as in claim 2, wherein the plurality of cellulose fibers have a Canadian standard freeness of greater than or equal to 45 CSF and less than or equal to 800 CSF.

13. A pasting paper as in claim 2, wherein the plurality of glass fibers comprise microglass fibers.

14. A pasting paper as in claim 2, wherein the plurality of glass fibers comprise chopped strand glass fibers.

15. A pasting paper as in claim 2, wherein the pasting paper has a mean pore size of greater than or equal to 2 microns and less than or equal to 100 microns.

16. A pasting paper as in claim 2, wherein the pasting paper has a specific surface area of greater than or equal to 0.1 m²/g and less than or equal to 10 m²/g.

17. A pasting paper as in claim 2, wherein the pasting paper is configured to have a mean pore size of greater than or equal to 2 microns and less than or equal to 300 microns after storage in 1.28 spg sulfuric acid at 75° C. for 7 days.

18. A pasting paper as in claim 2, wherein the pasting paper is configured to have an air permeability of greater than or equal to 100 CFM and less than or equal to 1300 CFM after storage in 1.28 spg sulfuric acid at 75° C. for 7 days.

19. A pasting paper as in claim 2, wherein the pasting paper has an electrical resistance of greater than or equal to 5 milliΩ·cm² and less than or equal to 100 milliΩ·cm².

20-21. (canceled)

22. A lead-acid battery comprising the pasting paper of claim 2, wherein the lead-acid battery comprises an electrolyte, and wherein the electrolyte comprises sulfuric acid.

23. A lead-acid battery as in claim 22, wherein, upon exposure of the battery plate to the electrolyte, at least a portion of the pasting paper dissolves in the electrolyte.

24. A lead-acid battery as in claim 23, wherein, after dissolution of at least a portion of the pasting paper in the electrolyte, a mean pore size of the pasting paper is greater than a mean pore size of the pasting paper prior to dissolution of at least a portion of the pasting paper in the electrolyte.

25. A lead-acid battery as in claim 23, wherein, after dissolution of at least a portion of the pasting paper in the electrolyte, an air permeability of the pasting paper is greater than an air permeability of the pasting paper prior to dissolution of at least a portion of the pasting paper in the electrolyte.
